(19) United States
(12) Patent Application Publication
(10) Pub. No.: US 2022/0039375 A1
(43) Pub. Date: Feb. 10, 2022

(54) Method of Producing Iodine-Supporting Composite Material

(71) Applicant: Kaken Co., Ltd., Mito-shi (JP)

(72) Inventors: Katsuyoshi TATENUMA, Mito-shi (JP); Yoshiaki KINASE, Mito-shi (JP); Junko MATSUI, Mito-shi (JP); Hitomi KAKUTA, Mito-shi (JP); Tsutomu KOJIMA, Mito-shi (JP); Yuri NATORI, Mito-shi (JP)

(21) Appl. No.: 17/022,656

(22) Filed: Sep. 16, 2020

(30) Foreign Application Priority Data
Aug. 5, 2020 (JP) 2020-133070

(51) Int. Cl. A01N 25/08; B01J 20/20; B01J 20/26; B01J 20/24; A01N 25/10; A01N 59/12

(52) U.S. Cl. CPC A01N 25/08; B01J 20/205; B01J 20/262; A01N 59/12; B01J 20/261; A01N 25/10; B01J 20/24

(57) ABSTRACT

Provided is an iodine-supporting composite material, which controls the volatility and elution of iodine by making iodine supported on plural kinds of activated carbon or fiber and mixing them, thereby the intensity of the bactericidal effect against microorganism can be changed. Migrating iodine from the state strongly retained in a material such as activated carbon or fibers to the material such as activated carbon or fibers having weak iodine adsorptivity which is made contacted, mixed, compounded, or mixed-spun with the strong iodine-adsorptivity materials, thereby, the rate of releasing iodine into the air or elution in water can be controlled. The iodine acts on the surrounding microorganisms in proportion to the rate at which iodine volatilizes or elutes and the intensity of these actions can be controlled.

### TECHNICAL FIELD

The present invention relates to an iodine-supporting material that controls antibacterial and antiviral effects by combining materials such as activated carbon and fibers (or, fabric) and impregnating with iodine.

### BACKGROUND ART

Iodine (I₂) is one of the halogen elements and has a strong biochemical effect, bactericidal power, and disinfection power. Iodine is a disinfectant that dissolves relatively well in alcohol, and iodine tincture dissolved in ethyl alcohol also has strong bactericidal power. However, iodine tincture is highly invasive and is stimulatory to the living body having reactivity with the living body. For this reason, povidone-iodine, in which polyvinyl-pyrrolidone and iodine are mixed to weaken the effect on the living body, is used as a wound medicine and a mouthwash. The iodine-based disinfectant is a medium-level disinfectant having the same efficacy as the chlorine-based disinfectant and has a sterilizing and disinfecting effect on bacteria, viruses, and molds (hereinafter referred to as microorganisms).

Iodine can be adsorbed and supported in the form of an elemental state (I₂) on polyurethane, nylon, and activated carbon on which iodine is easily adsorbed. This process uses the volatility of the elemental iodine (I₂), or such characteristics of iodine that the iodine becomes polyiodide ion (I₃⁻, I₅⁻) state when dissolved in sodium iodide (NaI) or potassium iodide (KI). By exposing to or impregnating those materials, i.e. polyurethane, etc. with the iodine of such a state, the iodine is adsorbed and supported thereon. As described in Patent Literatures 1 and 2, inventions have been filed for an invention of iodine activated carbon that sterilizes microorganisms adsorbed in the pores of activated carbon in a non-invasive manner for a living body. Further, the invention of a material having antibacterial and antiviral properties by applying iodine to the material such as the fiber described in Patent Document 3 has also been filed.

### LITERATURE OF CONVENTIONAL ART

### {Patent Literature}

### {Patent Literature 1} Japanese Patent Application No. 2017-102762

### {Patent Literature 2} Japanese Patent Application No. 2018-032302

### {Patent Literature 3} Japanese Patent Application No. 2019-019044

### SUMMARY OF INVENTION

### Technical Problem

The inventions described in Patent Literatures 1 to 3 are invasive and can maintain their effect on a living body for a long period of time, but the strength of the effect cannot be controlled.

An object of the present invention to provide a solution to this problem. Provided is an iodine-supporting material that is capable of varying the strength of the effect of sterilizing microorganisms by controlling the volatility and the elution of iodine. The method of this controlling is supporting and mixing iodine on plural types of different raw materials such as activated carbon and fibers.

### Solution to Problem

To solve the above problems, in the present invention, activated carbon and fibers having strong adsorptivity of iodine, and further another kind of activated carbon and fibers having weak adsorptivity of iodine, are made contact, mixed, made composite, and made mixed-spun.

As a method of supporting iodine on a material, there are an aqueous phase treatment and a vapor phase treatment. In the aqueous phase treatment, first, iodine simple substance (I₂) is dissolved in potassium iodide (KI) aqueous solution or a sodium iodide (NaI) aqueous solution to form polyiodide ion (I₃⁻, I₅) state. By immersing the material in the aqueous solution, iodine is adsorbed to the material and held stably. In this wet processing, applicable material is limited to such material that can retain iodine chemically stable.

Since iodine has a subliming property, iodine can be also iodized also by a method of adsorbing and occluding iodine gas obtained by vaporizing iodine. In this dry processing, applicable material is limited to such material that can keep iodine chemically stable. Iodine gas has a relatively weak bond between atoms, it, therefore, may be dissociated at a high temperature into a monoatomic molecule, and is supported by a material in the state of elemental iodine. Elemental iodine is the same as a free radical produced by irradiating iodine simple substance with ultraviolet rays or so and has high chemical activity. Elemental iodine includes not only a monoatomic molecule of iodine but also iodine simple substance.

Polyiodine is molecularly adsorbed (covalently bonded) by Van der Waals force (intermolecular force bond). Further, in elemental iodine, plural monatomic molecules are physically and chemically strongly bonded by forming a multi-bond (multiple bond: FIG. 1) in a network form. With this, elemental iodine is stably supported on the raw material for a long time in a state without releasing into the air or elution into water while maintaining its chemical activity.

In addition, the following substances are listed as the material having a strong iodine adsorptivity. A substance such as highly activated granular or fibrous activated carbon having iodine adsorptivity of about 700 to 1500 mg (I₂)/g; or alternatively, a substance, which has the iodine adsorptivity of about 1000 to 5000 mg (I2)/g, such as a substance having polyurethane structure, which includes nitrogen atom in the principal chain of its polymer structure or substance having polyamide structure such as nylon or wool of animal fiber.

Further, examples of the iodine-supporting material having a weak iodine adsorptivity include the following substances. A substance such as granular or fibrous activated carbon with a low degree of activation having an iodine adsorptivity of about 100 to 300 mg (I₂)/g; or alternatively, a fiber of such as polyvinyl alcohol (PVA), vinylon, or polypropylene having an iodine adsorptivity of about 100 to 500 mg (I₂)/g.

Furthermore, the iodine-supporting material for controlling the elution rate or volatilization rate of iodine by the present invention is characterized in that materials having a strong iodine adsorptivity and materials having a weak iodine adsorptivity are made to contact, mix, compound, or to be used in mixed-spun.

### Advantageous Effects of Invention

In the invention, iodine migrates from the state strongly retained in materials such as activated carbon or fibers that have strong iodine adsorptivity to the material of weak adsorptivity for iodine such as activated carbon or fiber, in which such weak adsorptivity material is contacted, mixed, composited, or mixed-spun with the material having strong iodine adsorptivity. With this iodine migration, the rate of iodine releasing into the air or elution in water is controlled, and the iodine acts on the surrounding microorganisms in proportion to the rate of evaporation or elution, so that the strength of the antibacterial and antiviral effects can be controlled.

According to this invention, the volatilization or elution property of iodine which has a strong antiviral action can be controlled. That is, by supporting this function on proper material, makes it possible to use such function in antivirus and antibacterial masks as measures against respiratory infections such as SARS coronavirus, MERS coronavirus, and influenza virus.

Furthermore, according to the present invention, a composite material having a positive iodine-releasing function can be used as an iodine gas-emitter for treating respiratory diseases and infectious diseases caused by bacteria or viruses.

### BRIEF DESCRIPTION OF DRAWINGS

FIG. 1 This is a figure showing the structure of the iodine supporting composite material of the present invention.

FIG. 2 This is a figure showing migration and desorption of iodine from the iodine supporting composite material of the present invention.

FIG. 3 This is a diagram showing the strength of the adsorption of iodine, and the antibacterial property due to the migration and release of iodine in the iodine-supporting composite material of the present invention.

FIG. 4 This is a figure showing the result of the antibacterial test of the iodine supporting composite material of the present invention.

FIG. 5 This is a table showing the result of the antiviral test of the iodine supporting composite material of the present invention.

FIG. 6 This is a figure showing an example of the use of the iodine-supporting composite material of the present invention.

### MODE OF IMPLEMENTING INVENTION

Hereunder, examples of embodiment of the present invention will be described in detail referring to the drawings.

### Example 1

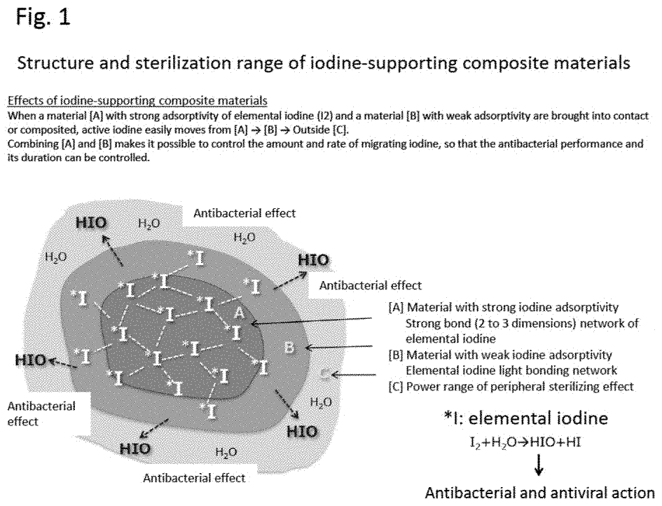

The iodine-supporting material of the present invention will be described. FIG. 1 is a diagram illustrating the structure of an iodine-supporting composite material. The invented iodine-supporting material is comprised of a first material ([A] in FIG. 1) and a second material ([B] in FIG. 1) arranged around the first material. The first material is, for example, activated carbon or fiber which has strong iodine adsorptivity and the second material is, for example, another kind of activated carbon or fiber having weak iodine adsorptivity. These two supporting materials were simultaneously processed to support iodine (I₂) by water-phase (liquid phase) processing or gas-phase processing. With this simultaneous processing, these two materials become an antibacterial and antiviral material which supports iodine in a composite manner.

Examples of the material having a strong adsorptivity for iodine includes granular or fibrous high-activated carbon, synthetic fibers such as nylon and polyurethane, wool (natural fiber). In contrast, a material having weak adsorptivity for iodine includes, for example, granular or fibrous weak-activated carbon, synthetic fibers such as polyvinyl alcohol (PVA), vinylon, polypropylene, polyester, acrylic, and the like.

The energy gap required for desorption from [A], which strongly adsorbs iodine, is large. It is therefore difficult to control the volatilization and elution of iodine with [A] alone. On the other hand, combining the material [A] with the material [B] having a weak iodine adsorptivity makes the energy gap necessary for iodine to migrate, volatilize, and elute from [A] to [B] and from [B] to [C] to be narrow. The narrowed energy gap makes the required iodine supply from the iodine-supporting material that exhibits an antibacterial effect to proceed smoothly.

When iodine is supported on activated carbon, the graphene structure of which adsorbs iodine in an elemental active state and retains. The iodine adsorptivity of activated carbon is proportional to its specific surface area and is about 700 to 1500 mg (I₂)/g in a high activation rate carbon.

When fiber is supporting iodine, the fiber is dyed. Since the polyiodide ion has a negative charge, if a material such as nylon has a positive charge, iodine will not elute out even if the material supporting iodine is washed with water. That is, if the dyeing remains, the iodine remains and the antibacterial and antiviral effect also remains.

Polyurethane is a polymer having a urethane bond (covalent bond between the nitrogen of amine and the carbon of carbonyl group). As with nylon, iodine is strongly adsorbed and supported on fiber by a linear bonding of polyiodine to the nitrogen element. Wool (sheep wool) also contains many nitrogen atoms in its fiber structure and can support iodine. It should be noted that these fibers may be a mixed-spun of plural fibers, or may be a flocked material to other materials.

Polypropylene is a crystalline plastic and has a crystallinity of 40 to 70%. If its crystallinity is low, it is possible to sandwich and support polyiodide ions between the molecular chains of the crystalline part and the amorphous part, like polyvinyl alcohol (raw material for vinylon).

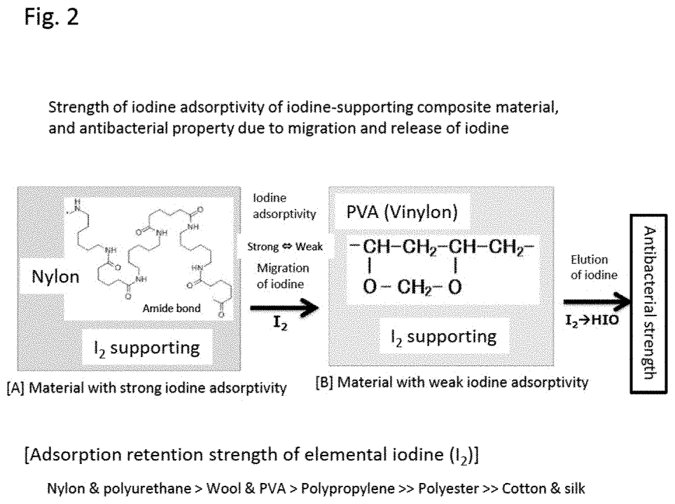

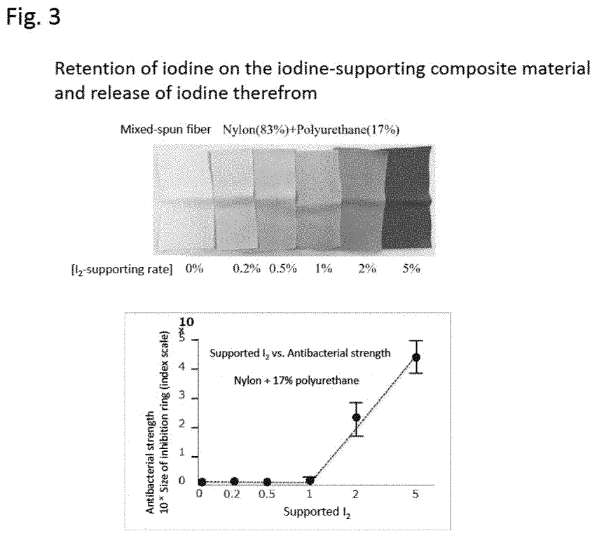

In the substances with weak iodine adsorptivity such as activated carbon of low-activation, fibers like cotton, silk, acrylic, polyester (polyethylene terephthalate, etc.), rayon, etc., which contain a large amount of oxygen or hydroxyl groups in the principal chain or side chain of their polymer structure, it is difficult to support iodine and the iodine therein easily evaporates into air or elutes into water. Therefore, making those low-activated substances with weak iodine adsorptivity contact, mix, compound, or mix-spin with the substances having high iodine-adsorptivity such as activated carbon of high-activation, polyurethane, nylon, wool, etc. allows adsorbed iodine to migrate distributively from the material having a strong iodine adsorptivity to the material having a weak iodine adsorptivity, and then migrated iodine flows outside. FIG. 2 schematically shows the concept of antibacterial property due to the movement of adsorbed iodine and release from the material. FIG. 3 shows the data in the case where iodine is supported stepwise on a mixed-spun fabric of nylon (83%)+polyurethane (17%) each having the same iodine adsorptivity. The data is shown in terms of the relationship between the amount of supported iodine and the antibacterial strength. For the case of a mixed-spun fiber of the same degree of iodine adsorptivity, it was confirmed that the antibacterial strength increases exponentially with a certain concentration of supported iodine as a border.

Iodine has considerably strong bactericidal and antiviral powers when in the state of iodine alone or elemental iodine, however, in the state of iodine ion (I⁻), iodine loses its bactericidal power. In addition, the bactericidal power of iodine is maintained when its chemical form is triiodide ion (I₃⁻), pentaiodide ion (I₅⁻), iodate ion (IO₃⁻), periodate ion (IO₄⁻), etc. However, if dissolved in water and diffused, their bactericidal power is impaired since they are water-soluble. Therefore, the iodine in this description does not include one in the state of iodine ion (iodide ion), triiodide ion, or (per)iodate ion.

Iodine has no antibacterial and antiviral effect when it is in a reducing state because it becomes an iodine ion state. Further, when the potential is in an extremely oxidized state, it becomes a state such as an iodic acid ion so that the oxidizing power (antibacterial and antiviral effect) is strong, but since it is water-soluble, the effect does not last long. If the pH (hydrogen ion concentration) is neutral or acidic or between such states, the state of elemental iodine is maintained, it has an oxidizing power (effect of antibacterial and antiviral), and it is hard to dissolve in water, thus the effect lasts a long time. When the pH becomes alkaline, the iodine becomes in a state of iodic acid ion or iodine ion, so that the sustainability of the effect cannot be expected.

The antibacterial and antiviral composite material of the present invention inactivates microorganisms. Inactivation is the death of microorganisms and the loss of infectivity. Specifically, the iodine cation oxidizes cysteine, which is an amino acid residue of a protein in the living body, and iodinates tyrosine and histidine to change the protein. Note that inactivation includes sterilisation (killing microorganisms), bacteria-killing (killing harmful virus), disinfection, bacteria-removing (removing virus), antibacterial treatment (stop the virus propagation), etc.

Microorganisms include viruses, fungi (molds) and bacteria. The virus includes SARS coronavirus, MERS coronavirus, Zika virus, (avian) influenza virus, norovirus, Ebola hemorrhagic fever virus, foot-and-mouth disease virus, human immunodeficiency virus (HIV), etc. Although viruses are not defined as organisms by definition, they are included in microorganisms. Fungi (mold) are fungi such as Trichophyton. Bacteria include highly durable spores such as Bacillus subtilis and Natto bacteria, and general bacteria such as plague bacillus, tubercle bacillus, E. coli, cholera, and salmonella.

For example, disinfectants include high-level disinfectants that are effective against most spores, medium-level disinfectants that are effective against tubercle bacillus and most fungi and viruses, and low-level disinfectants that are effective against most common bacteria and some fungi and viruses. Resistance to antiseptics is in order from strongest to spore bacterium, virus, tubercle bacillus, and general bacteria. Iodine is a medium-level disinfectant similar to chlorine, and is effective against microorganisms except for some spore-forming bacteria that are resistant to iodine.

### Example 2

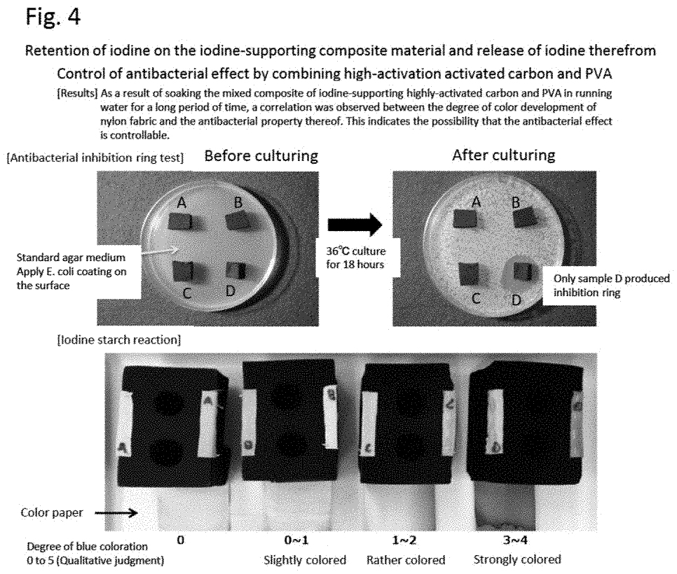

Next, the retention and release of the antibacterial strength of the iodine-supporting material will be described. FIG. 4 shows the results of an antibacterial test on polyvinyl alcohol (PVA) containing activated carbon with high-activation as the iodine-supporting composite material.

Polyvinyl alcohol (PVA) containing activated carbon of high-activation was formed into square-shaped samples A to D as shown in FIG. 4, which were made support iodine stepwise by the dry processing or the wet processing, and then washed sufficiently with water. When an activated carbon with high-activation supporting iodine is not compounded in PVA, the elution of iodine to the outside does not occur. However, when compounded in PVA, it was confirmed, as shown in FIG. 4, that the activated iodine eludes proportionally to the supporting conditions.

The elution phenomenon of this active iodine from the active carbon with high-activation indicates that PVA, which weakly adsorbs iodine, is in a state serving as a supporter for desorbing iodine strongly adsorbed in the active carbon and eluting to the outside. In the case of this combination of nylon and PVA, the elution phenomenon of iodine is different from the case of the above-mentioned mixed-spun fiber of nylon and polyurethane both having strong iodine adsorptivity, and the elution of iodine is accelerated and easily elutes at a constant concentration.

Iodine-supporting activated carbon, nylon, nylon+polyurethane (mixed-spun product) retains iodine even when exposed to running water for a long time or strongly treated by an autoclave (pressurized steam atmosphere, 121° C., 30 minutes). Its antibacterial property is not lost for a long time.

On the other hand, in the case of the iodine-supporting mixed-spun product of nylon+polyester or polyurethane+cotton of the present invention, the retained iodine is desorbed and eluted in a short time when exposed to running water. Especially when autoclaved, elution of the iodine is accelerated, its antibacterial property disappears.

### Example 3

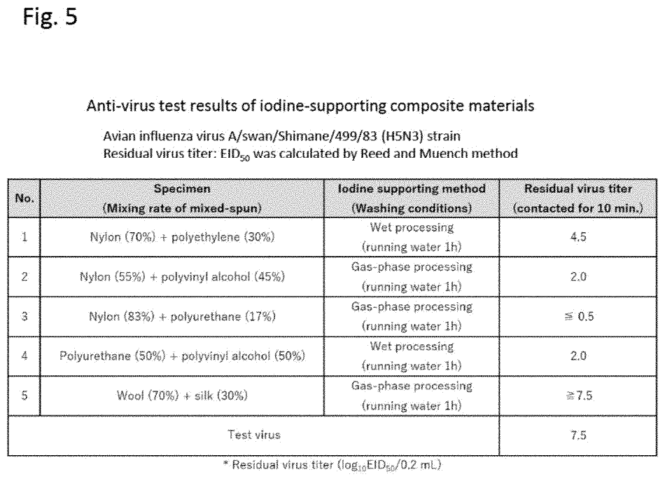

Next, the antiviral property of the iodine-supporting composite material will be described. FIG. 5 shows the result of the antiviral test of the iodine-supporting composite material.

As shown in FIG. 5, the following materials were prepared as test samples.

(1) A mixed-spun fabric of nylon (70%) and polyethylene (30%) in which iodine is supported thereon by wet processing,

(2) A mixed-spun fabric of nylon (55%) and polyvinyl alcohol (45%) in which iodine is supported thereon by gas-phase processing,

(3) A mixed-spun fabric in which nylon (83%) and polyurethane (17%) are mixed-spun and iodine is supported thereon by gas-phase treatment,

(4) A mixed-spun fabric in which polyurethane (50%) and polyvinyl alcohol (50%) are mixed-spun and iodine is supported thereon by wet processing, and

(5) A mixed-spun fabric in which wool (70%) and silk (30%) are mixed-spun and iodine is supported thereon by gas-phase processing.

Each sample was exposed to running water for 1 hour continuously after iodine was made supported thereon. Each sample was cut into 1.5 cm square of test specimen, then put to the antiviral test.

The virus used in the test was the avian influenza virus A/swan/Shimane/499/83 (H5N3) strain. This virus was inoculated into the allantoic cavity of 10-day-old embryonated chicken eggs and incubated at 35° C. for 2 days, and then, the allantoic cavity fluid was collected and used as a virus solution. Calculating the 50% embryonated egg concentration (EID₅₀), the material was prepared to about 10^{7.5} EID₅₀/0.2 mL using PBS (phosphate-buffered saline).

Each of the cloths of samples (1) to (5) were cut into pieces of 1.5 cm square (about 0.4 g each) and put in polyethylene bags. The specimen in the bag was inoculated with 200 μL of the virus solution, then rubbed to impregnate the solution thoroughly, and allowed to react at room temperature for 10 minutes. After the reaction, SCDLP medium was added to dilute 10-fold. Then they were stepwise-diluted 10-fold with PBS, and, at each dilution step, the diluted cell was inoculated by 0.2 mL into three 10-day-old embryonated egg allantoic cavities, and the cells were cultured at 35° C. for 2 days. After the culture, the allantoic cavity fluid was collected and left in a cool dark room overnight then reacted with 0.5% chicken red blood cell suspension, and the occurrence or non-occurrence of virus growth was determined by the aggregation of red blood cells. The residual virus titer was calculated with EID₅₀ by the method of Reed and Muench.

The inactivation effect against the avian influenza virus was examined for each of the fabrics supporting the iodine. The examination found that, whereas the titer of the test virus solution was 7.5, specimen (1) gained 4.5, specimen (2) 2.0, specimen (3) 0.5 or less, specimen (4) 2.0, and specimen (5) 7.5 or more.

From these results, it was found that the virus titer of the specimens of mixed-spun fabric (2), (3), and (4), each of which is a mutual-combination of materials each having strong iodine adsorptivity, is reduced to 0.5 or less as the titer of the lowest example or reduced to 2.0 even as the highest value case (i.e., reduced to 1/10,000,000 to several hundredths of a million) even when contacted with the virus solution for 10 minutes. This shows that the virus inactivating effect of them is extremely high. On the contrary, it was found that the specimens (1) and (5), which are the mixed-spun fabric of materials having strong iodine adsorptivity and weak iodine adsorptivity, has the virus titers of 4.5 to 7.5 or higher (i.e., 1/1000 to not-effective) after the test. This result shows that active iodine was eluted out by the running water treatment after the iodine was supported.

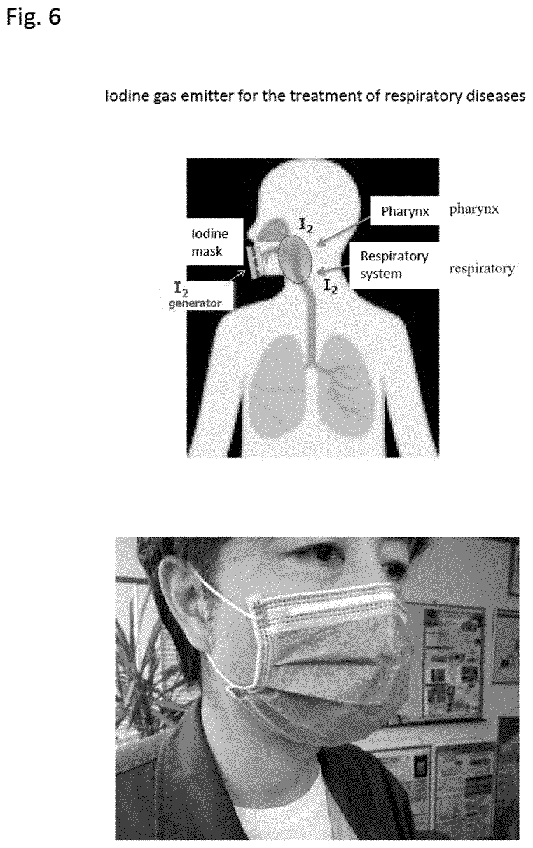

According to the present invention, the volatilization or elution property of iodine, which has a strong antiviral effect, can be controlled, and therefore, the invention can be applied to an antibacterial antiviral mask for respiratory infectious diseases by making such function to support. That material can be used in an anti-virus function mask of which constituent material having such as activated carbon (iodine-supporting activated carbon) on which elemental iodine is adsorbed as shown in FIG. 4. Further according to the present invention, a composite material, to which active iodine releasing function is given, can be used as an iodine gas-emitter (FIG. 6) for treating respiratory diseases and infectious diseases caused by bacteria or viruses.

Although the embodiments of the present invention have been described above, the present invention is not limited thereto. The iodine-supporting material by the present invention can be used for various purposes. The use application includes: masks, gloves, protective clothing for measures against infectious diseases; iodine release materials for medical use, sportswear, general clothing and clothes, socks; escalator handrail, arm rail, strap, seat cover; aircraft flooring material, daily necessities and public goods (slippers, toilet seat cover, touch panels for game consoles and ATMs, keyboards for personal computers); medical and nursing care products (surgical clothes, surgical tools, bedsheets to prevent bedsores); and agricultural sheets.

1. A method of producing an iodine-supporting composite material, which material comprising a first material that strongly adsorbs elemental iodine and a second material that weakly adsorbs elemental iodine, wherein composite ratio of said first material and said second material is changed so that biochemical activity of iodine is controlled according to volatilization ratio of iodine in air or elution ratio of iodine in water.

2. The method of producing an iodine-supporting composite material according to claim 1, wherein said first material that strongly adsorbs iodine is activated carbon having iodine adsorptivity of 700 to 1500 mg (I₂)/g, or a substance having urethane structure that includes nitrogen atom in the principal chain of its polymer structure, or a substance having polyamide structure such as polyurethane, nylon, or wool of animal fiber, wherein a fiber of such substance has iodine adsorptivity of 1000 to 5000 mg (I₂)/g; wherein said second material that weakly adsorbs iodine is a low-activated granular or fibrous activated carbon having iodine adsorptivity of 100 to 300 mg (I₂)/g, or polyvinyl alcohol (PVA), vinylon, or polypropylene wherein iodine adsorptivity of said material is 100 to 500 mg (I₂)/g.

3. The method of producing an iodine-supporting composite material according to claim 1, wherein iodine is sublimated and adsorbed as the method of making elemental iodine to adsorb to said first material or said second material.

4. The method of producing an iodine-supporting composite material according to claim 1, wherein elemental iodine is adsorbed on said first material or said second material in a state of polyiodide ion in an aqueous solution.

5. The method of producing an iodine-supporting composite material according to claim 1, wherein said first material that strongly adsorbs elemental iodine is a substance that has graphene structure, urethane structure, or polyamide structure; wherein said second material that weakly adsorbs elemental iodine is a substance that has graphite structure, polyvinyl structure, or polyester structure; and wherein producing said composite material is performed changing the composite ratio of said two substances.

6. The method of producing an iodine-supporting composite material according to claim 1, wherein said first material that strongly adsorbs elemental iodine is activated carbon, polyurethane, nylon, polypropylene, wool, or a mixture thereof; and wherein said second material that weakly adsorbs elemental iodine is charcoal, graphite, polyvinyl alcohol, polyester, cotton, or their mixture.

7. The method for producing an iodine-supporting composite material according to claim 1, wherein the iodine-supporting composite material includes material that adsorbs elemental iodine.

8. The method of producing an iodine-supporting composite material according to claim 1, wherein said iodine-supporting composite material is for measures for infectious diseases including masks, gloves, and protective clothing; or said composite material is for iodine releasing materials for medical use; or said composite material is for apparel including sportswear, general clothing and clothes, and socks; or said composite material is for escalator handrail, arm rail, strap, seat cover, or flooring materials of aircrafts, or said composite material is for daily necessities and goods, medical and nursing care products, or agricultural sheets.
